(19) United States
(12) Patent Application Publication
(10) Pub. No.: US 2006/0098244 A1
(43) Pub. Date: May 11, 2006

(54) Image sensor assembly and method for fabricating the same

(75) Inventors: Yong-Hwan Choi, Suwon-si (KR); Young-Kwon Yoon, Anyang-si (KR); Gi-Tae Mun, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/180,236

(22) Filed: Jul. 13, 2005

(30) Foreign Application Priority Data
Nov. 5, 2004 (KR) 2004-89865

(51) Int. Cl. H04N 1/04

(52) U.S. Cl. 358/474

(57) ABSTRACT

Provided is an image sensor assembly and a method for fabricating the same. The image sensor assembly includes an image sensor and a transparent cover. The image sensor detects an image has an exposed light receiving circuit on its surface. The transparent cover has a support. The support protrudes from the surface of the transparent cover to define a predetermined area on the surface of the transparent cover. The support is bonded to the surface of the image sensor to surround the light receiving circuit. The light receiving circuit is sealed by the transparent cover.

### CLAIM OF PRIORITY

This application claims priority under 35 U.S.C. § 119 to an application entitled “Image Sensor Assembly and Method for Fabricating the Same,” filed in the Korean Intellectual Property Office on Nov. 5, 2004 and assigned Serial No. 2004-89865, the contents of which are incorporated herein by reference.

### BACKGROUND OF THE INVENTION

1. Field of the Invention

The present invention generally relates to an image sensor, and in particular, to an image sensor assembly having a light receiving circuit and a method for fabricating the image sensor assembly, in which an image is input to the light receiving circuit.

2. Description of the Related Art

Mobile phone camera modules are evolving to incorporate various additional functionalities such as auto-focus and optical zoom. In particular, they are quickly moving to digital camera level high pixel resolution. Consequently, the mobile phone camera modules should be miniaturized. A method for packaging an image sensor in a camera module can be roughly classified into chip on board (COB) and chip on film (COF). Since COB provides a stable process, it is preferred for a high-pixel camera module. Since COF facilitates mass production, it is used for camera modules having less than 1 mega pixels. The process of packaging an image sensor involves allowing the image sensor to exchange an electric signal with the outside and sealing the image sensor to be resistant against external shock. An image sensor is a semiconductor chip that converts an image signal into an electric signal. They can be roughly classified into a complementary metal oxide semiconductor (CMOS) image sensor and a charger coupled devices (CCD) image sensor.

FIG. 1 is a conventional COF. The COF includes forming a bump that is an external access terminal on the top of an image sensor 130 having a light receiving circuit 135 (referred to as bumping). Dispensing epoxy onto an infrared cutoff filter (IR filter) or a transparent cover 140 like glass to cover the top of a hole 115 included in a flexible printed circuit board (FPCB) 110. Attaching the IR filter or the transparent cover 140 to the FPCB 110. Bonding the image sensor 130 onto the bottom surface of the FPCB 110 (referred to as flip chip bonding) to cause an anisotropic conductive film (ACF) 120 around the bottom of the hole 115 to contact the bump. Since the image sensor 130 is bonded to the bottom of the FPCB 110 in COF, COF is useful for miniaturization. Automation for COF is difficult, but it has come into common use as a mass production method for camera modules having 0.3 mega pixel CMOS image sensors.

FIG. 2 is a conventional COB. The COB includes attaching an image sensor 220 having a light receiving circuit onto a printed circuit board (PCB) 210 (referred to as die attaching). Electrically connecting the PCB 210 and the image sensor 220 using a wire 240 and a pad 230 (referred to as wire bonding).

However, conventional packaging methods have a number of problems as below.

First, according to COF, since the light receiving circuit 135 of the image sensor 130 is exposed at the time of flip chip bonding, there is a high possibility of failure due to contamination regardless of bonding yield. Further, the process of attaching an IR filter or glass is also vulnerable to contamination.

Second, according to COB, since the light receiving circuit of the image sensor 220 is exposed at the time of wire bonding, there is a high possibility of failure due to contamination. Although the image sensor 220 may be sealed with glass to prevent contamination of the image sensor 220, for example, in a ceramic leadless chip carrier (CLCC) type, the size of the image sensor 220 may also increase. As a result, such a sealing method is not a fundamental solution for contamination.

### SUMMARY OF THE INVENTION

Accordingly, the present invention has been designed to reduce or overcome the above limitations, as well as other problems occurring in the prior art. One object of the present invention is to provide an image sensor assembly and a method for fabricating the same, in which contamination during packaging can be minimized.

In accordance with the principles of the present invention, there is provided an image sensor assembly. The image sensor assembly includes an image sensor and a transparent cover. The image sensor for detecting an image has an exposed light receiving circuit on its surface. The transparent cover has a support. The support protrudes from the surface of the transparent cover to define a predetermined area on the surface of the transparent cover and is bonded to the surface of the image sensor to surround the light receiving circuit. The light receiving circuit is sealed by the transparent cover.

To achieve the above and other objects, there is also provided a method for fabricating an image sensor assembly. The method includes the steps of (a) providing an image sensor wafer having a plurality of image sensor chips for image detection, each of which has an exposed light receiving circuit on its surface, (b) providing a plurality of transparent cover chips, each of which has a support that protrudes from the surface of the transparent cover chip to define a predetermined area on the surface of the transparent cover chip, (c) sealing the light receiving circuit using the transparent cover chip by bonding the support of the transparent cover chip to the surface of the image sensor wafer to cause the support of the transparent cover chip to surround the light receiving circuit, and (d) sawing the image sensor wafer into chip units.

### BRIEF DESCRIPTION OF THE DRAWINGS

The present invention will become more apparent from the following detailed description when taken in conjunction with the accompanying drawings in which:

FIG. 1 is a conventional COF;

FIG. 2 is a conventional COB;

FIG. 3 illustrates an image sensor assembly according to an embodiment of the present invention; and

FIGS. 4 through 14 are views for explaining a method for fabricating an image sensor assembly according to an embodiment of the present invention.

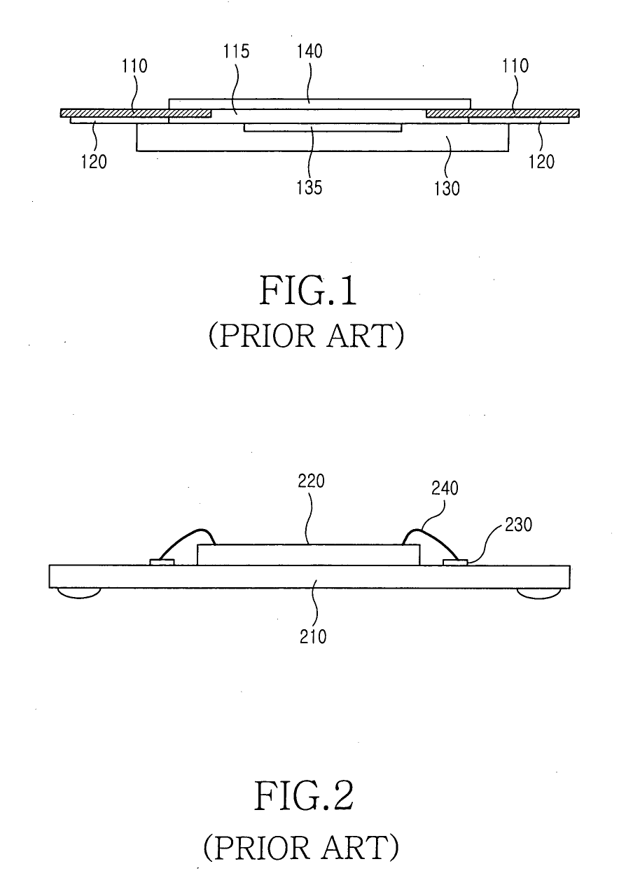

### DETAILED DESCRIPTION

Preferred embodiments of the present invention will be described in detail hereinafter with reference to the accompanying drawings. In the following description of the present invention, the same drawing reference numerals are used for the same elements even in different drawings. Additionally, a detailed description of known functions and configurations incorporated herein will be omitted when it may obscure the subject matter of the present invention. The terms are defined in consideration of their functions in the present invention and may differ in accordance with the intention of a user/operator or custom. Accordingly, they are defined based on the contents of the entire description of the present invention.

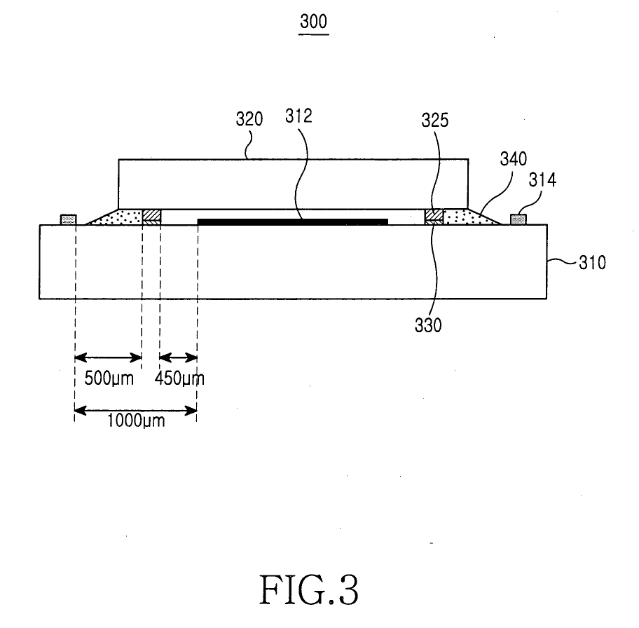

FIG. 3 illustrates an image sensor assembly according to a preferred embodiment of the present invention. An image sensor assembly 300 includes an image sensor 310 and a transparent cover 320.

The image sensor 310 illustratively takes the form of a rectangular plate. It has an exposed light receiving circuit 312 and a plurality of external access terminals 314 around the light receiving circuit 312 on its surface. The light receiving circuit 312 takes the form of a square and is located at the center of the surface of the image sensor 310. The external access terminals 314 taking the form of squares are spaced apart from the edge of the light receiving circuit 312 by 1 mm and are placed on the surface of the image sensor 310. The external access terminals 314 are also spaced apart from one another by a predetermined interval. The image sensor 310 may be a CMOS image sensor or a CCD image sensor and the external access terminals 314 may be bumps or pads.

The transparent cover 320 takes the form of a square plate and has a support 325 that takes the form of a square frame and extends or protrudes from the surface of the transparent cover 320 to define the square center of the surface of the transparent cover 320. One side of the support 325 has a square cross section and a width of 50 μm and a height of 70-100 μm. The transparent cover 320 may be an IR filter or glass.

As shown in FIG. 3, the light receiving circuit 312 of the image sensor 310 is covered or sealed by the transparent cover 320. The support 325 of the transparent cover 320 is bonded to the surface of the image sensor 310 using an adhesive, i.e., ultraviolet (UV) epoxy 330 to surround the light receiving circuit 312 of the image sensor 310. The edge of the light receiving circuit 312 is spaced apart from the support 325 by 450 μm and the support 325 is spaced apart from the external access terminals 314 by 500 μm. The external circumference of the support 325 is sealed using a liquid encapsulant 340. The encapsulant 340 is a supplementary means for the transparent cover 320 to more tightly seal the light receiving circuit 312.

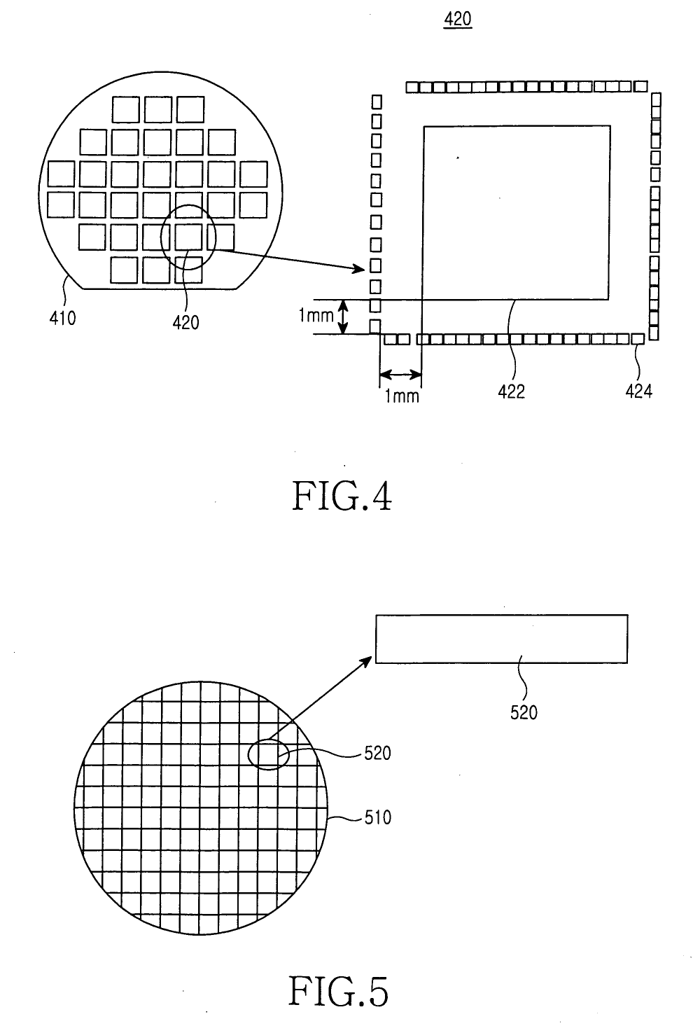

FIGS. 4 through 14 are views for explaining a method for fabricating an image sensor assembly according to a preferred embodiment of the present invention. The method includes steps (a) through (d) as follows.

Step (a) involves providing an image sensor wafer having a plurality of image sensor chips for image detection, each having an exposed light receiving circuit on its surface. Referring to FIG. 4, an image sensor wafer 410 and a plurality of image sensor chips 420 are shown. Each of the image sensor chips 420 takes the form of a square plate and has an exposed light receiving circuit 422 on its surface and a plurality of external access terminals 424 around the light receiving circuit 422. The light receiving circuit 422 takes the form of a square and is located at the center of the surface of the image sensor chip 420. The external access terminals 424 taking the form of squares are spaced apart from the edge of the light receiving circuit 422 by 1 mm and are placed on the surface of each of the image sensor chips 420. The external access terminals 424 are spaced apart from one another by a predetermined interval.

Step (b) involves providing a plurality of transparent cover chips. Each cover chip has a support that protrudes from the surface of the transparent cover chip to define a predetermined area on the surface thereof. Step (b) includes sub-steps (b-1) through (b-6) as follows.

As shown in FIG. 5, step (b-1) involves providing a transparent cover wafer 510 having a plurality of transparent cover chips 520.

Hereinafter, an illustrative description will be made on a chip basis for convenience of understanding.

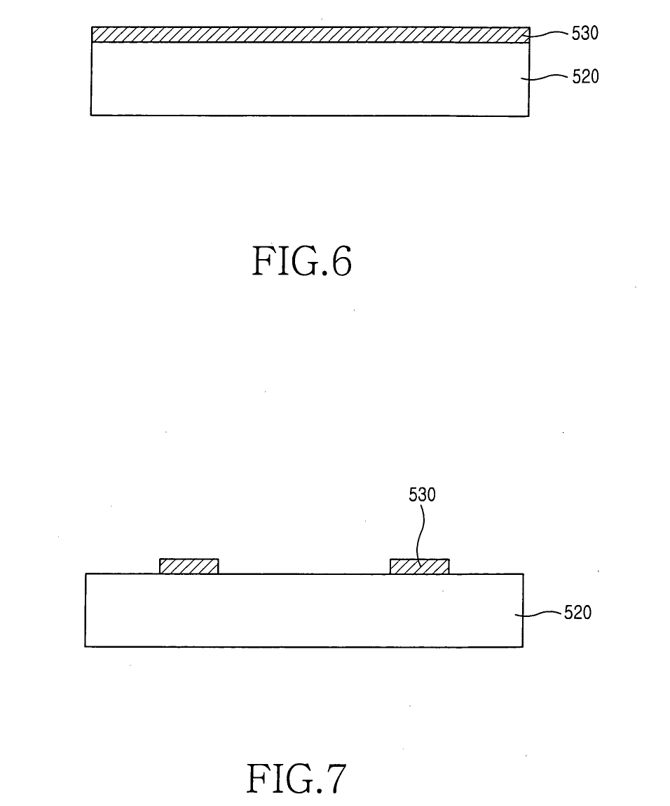

As shown in FIG. 6, step (b-2) involves applying a photoresist 530 onto the transparent cover chip 520.

As shown in FIG. 7, step (b-3) involves patterning the photoresist 530 to cause the photoresist 530 to take the form of a square frame.

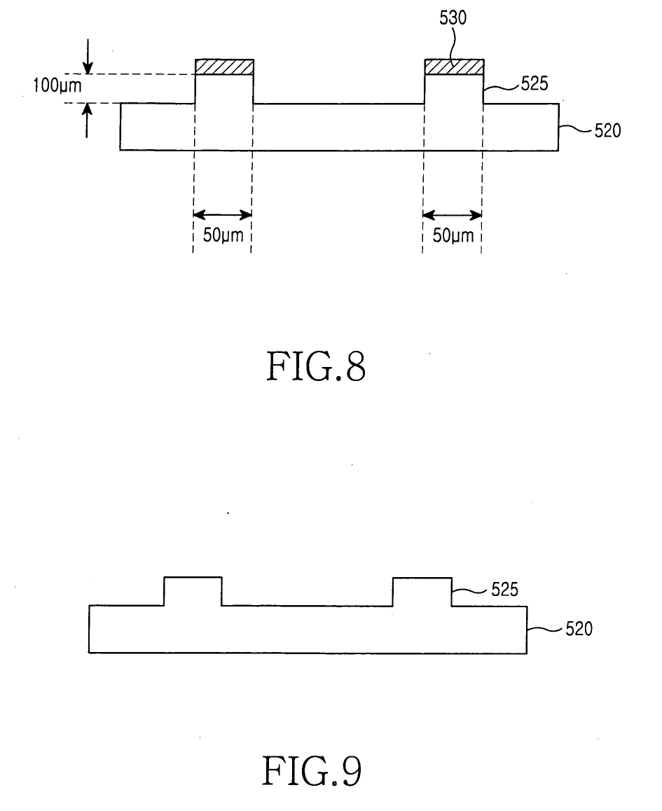

As shown in FIG. 8, step (b-4) involves etching the transparent cover chip 520 using the patterned photoresist 530 to form the support 525 taking the form of a square frame. One side of the support 525 has a square cross section and a width of 50 μm and a height of 70-100 μm.

As shown in FIG. 9, step (b-5) involves removing the photoresist 530 deposited onto the support 525.

Steps (b-2) through (b-5) are detailed steps of a photolithography process to cause the transparent cover chip 520 to have a predetermined pattern.

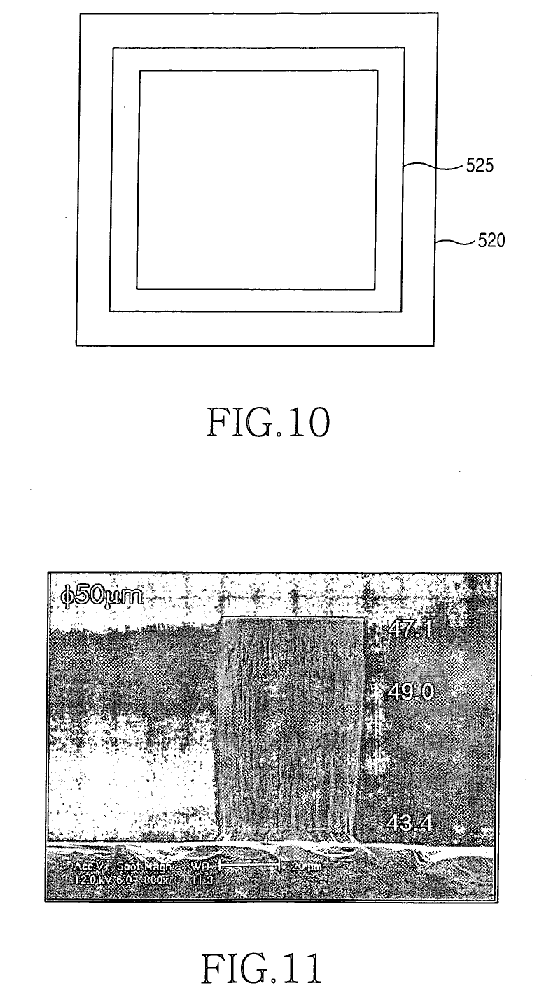

As shown in FIG. 10, step (b-6) involves sawing the transparent cover wafer 510 that undergoes the above steps to acquire the plurality of transparent cover chips 520 (referred to as singulation).

FIG. 11 illustrates an image of one side of the support 525 of the transparent cover chip 520 shown in FIG. 10, which is taken by a scanning electron microscopy (SEM).

Step (c) involves sealing the light receiving circuit 422 using the transparent cover chip 520. This step includes bonding the support 525 of the transparent cover chip 520 to the surface of the image sensor chip 420 to cause the support 525 to surround the light receiving circuit 422. Step (c) includes sub-steps (c-1) through (c-4).

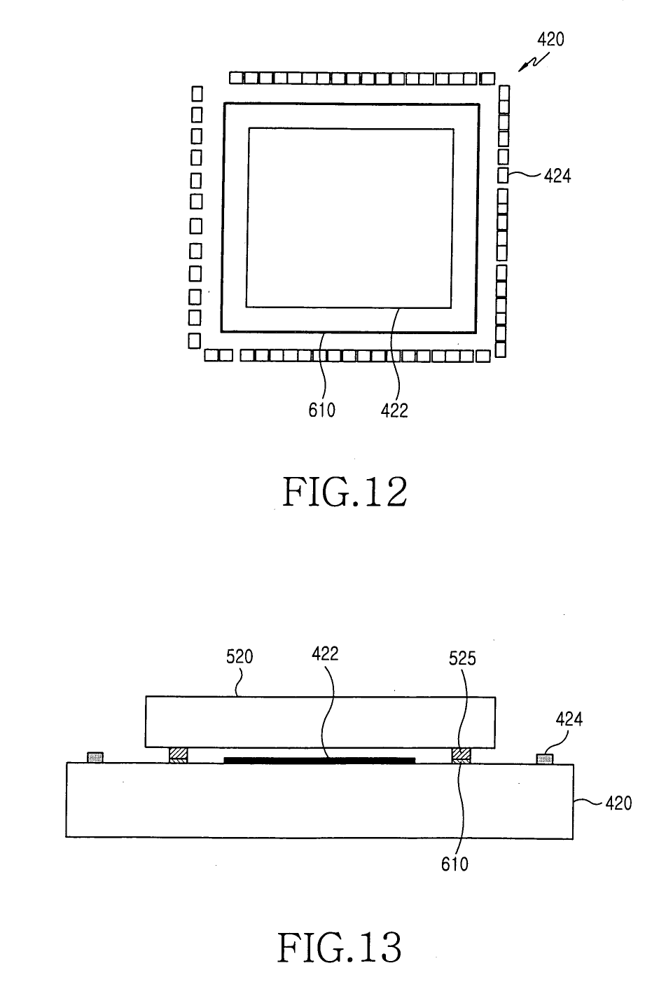

As shown in FIG. 12, step (c-1) involves dispensing UV hardening epoxy 610. UV hardening epoxy 610 is an adhesive and is spaced part from the edge of the light receiving circuit 422 by 450 μm onto the image sensor chip 420 of the image sensor wafer 410 shown in FIG. 4 in the form of a square. One side of the UV hardening epoxy 610 has a width of 50 μm. Since a general dispensing device can control an epoxy flow within 20-50 μm, it is not difficult to cause one side of the support 525 to have the 50 μm width.

As shown in FIG. 13, step (c-2) involves attaching the transparent cover chip 520 as shown in FIG. 10 onto the image sensor chip 420 of the image sensor wafer 410. The support 525 of the transparent cover chip 520 is placed on the UV hardening epoxy 610 of the image sensor chip 420. The support 525 surrounds the light receiving circuit 422 of the image sensor chip 420. Thus, the light receiving circuit 422 is sealed by the transparent cover chip 520.

Step (c-3) involves hardening the UV hardening epoxy 610 by radiating UV rays onto the UV hardening epoxy 610.

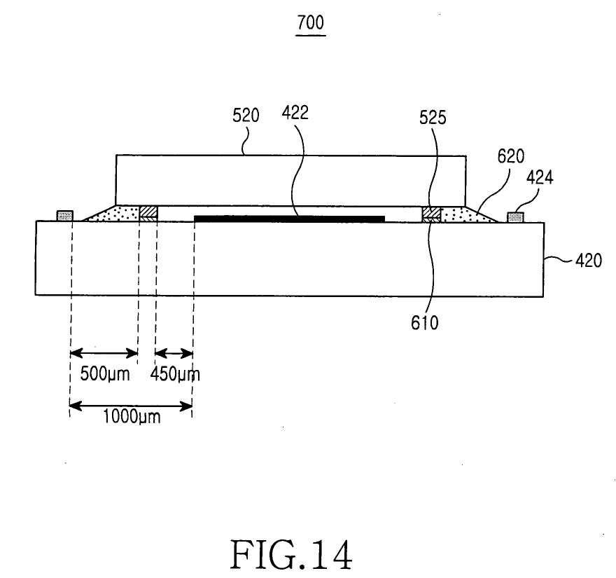

As shown in FIG. 14, step (c-4) involves sealing the external circumference of the support 525 using a liquid encapsulant 620. After being dispensed to the external circumference of the support 525, the encapsulant 620 is hardened. If the encapsulant 620 is thermosetting, it is heated for hardening. If a niddle type dispensing device is used, a space of 350 μm is required to prevent the encapsulant 620 from contacting the external access terminals 424. If a jetting type dispensing device is used, the required space can be reduced to 150 μm. Thus, it is possible to prevent the encapsulant 620 from spreading into the external access terminals 424. Since a space of about 1 mm is provided between the light receiving circuit 422 of the image sensor chip 420 and the external access terminals 424, there is no significant difficulty in a packaging process.

Step (d) involves forming a plurality of image sensor assemblies 700 by sawing the image sensor wafer 410 into chip units.

As described above, according to the present invention, a light receiving circuit is sealed using a transparent cover, thereby preventing contamination of the light receiving circuit during a subsequent packaging process, i.e., wire bonding in COB or flip chip bonding in COF.

While the invention has been shown and described with reference to a certain preferred embodiment thereof, it will be understood by those skilled in the art that various changes in form and details may be made therein without departing from the spirit and scope of the invention.

What is claimed is:

1. An image sensor assembly comprising:
an image sensor having an exposed light receiving circuit on its surface; and
a transparent cover having a support that protrudes from the surface of the transparent cover to define a predetermined area on the surface of the transparent cover, wherein the support is bonded to a surface of the image sensor to surround the light receiving circuit and the light receiving circuit is covered by the transparent cover.

2. The image sensor assembly of claim 1, wherein the image sensor is a complementary metal oxide semiconductor (CMOS) image sensor or a charger coupled devices (CCD) image sensor.

3. The image sensor assembly of claim 1, wherein the support takes the form of a square-like frame.

4. The image sensor assembly of claim 1, wherein the transparent cover is an infrared (IR) cutoff filter or glass.

5. The image sensor assembly of claim 1, wherein the support is bonded to the image sensor using ultraviolet (UV) hardening epoxy.

6. The image sensor assembly of claim 1, wherein the external circumference of the support is sealed using an encapsulant.

7. An image sensor assembly comprising:
an image sensor having a light receiving circuit on its surface; and
a transparent cover having a support that extends from a surface of the transparent cover forming a predefined space, wherein the support is bonded to a surface of the image sensor to surround the light receiving circuit and the light receiving circuit is covered by the transparent cover.

8. A method for fabricating an image sensor assembly, the method comprising the steps of:
(a) providing an image sensor wafer having a plurality of image sensor chips for image detection, each of which has an exposed light receiving circuit on its surface;
(b) providing a plurality of transparent cover chips, each of which has a support that protrudes from the surface of the transparent cover chip to define a predetermined area on the surface of the transparent cover chip;
(c) sealing the light receiving circuit using the transparent cover chip by bonding the support of the transparent cover chip to the surface of the image sensor wafer to cause the support of the transparent cover chip to surround the light receiving circuit; and
(d) sawing the image sensor wafer into chip units.

9. The method of claim 8, wherein step (b) comprises the steps of:
(b-1) applying a photoresist onto the transparent cover chip;
(b-2) patterning the photoresist to cause the photoresist to take the form of a square-like frame; and
(b-3) forming the support that takes the form of a square-like frame by etching the transparent cover chip using the patterned photoresist.

10. The method of claim 8, wherein step (c) comprises the steps of:
(c-1) dispensing an adhesive that is spaced apart from the edge of the light receiving circuit by a predetermined interval onto the image sensor chip of the image sensor wafer in the form of a square; and
(c-2) bonding the support of the transparent cover chip to the image sensor chip of the image sensor wafer to cause the support of the transparent cover chip to be placed on the adhesive of the image sensor chip.

11. The method of claim 9, wherein step (c) further comprises the step of (c-3) sealing the external circumference of the support using an encapsulant.
